(19) United States
(12) Patent Application Publication
(10) Pub. No.: US 2010/0073705 A1
(43) Pub. Date: Mar. 25, 2010

(54) PRINT JOB ASSIGNMENT METHOD ALLOWING USER-PRIORITIZATION

(75) Inventor: Shane Matthew Cain, Carlsbad, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/234,571

(22) Filed: Sep. 19, 2008

(51) Int. Cl. G06F 3/12; G06F 15/00

(52) U.S. Cl. 358/1.15; 358/1.13

(57) ABSTRACT

An automatic job assignment method implemented in a print job management apparatus for processing print jobs in a multiple-printer print shop environment described. Each print job is processed by comparing the printing requirements of the job with capabilities of the printers to find one or more candidate printers that can satisfy all job requirements. Then, from all such candidate printers, one printer is selected by evaluating real-time conditions of the printers, such as wait time, device status, periodic maintenance (PM) count, operation history, etc., and the print job is submitted to the selected printer. The real-time conditions and the order in which they are evaluated are set by the operator. The process can also be run in an alternative mode where one of the candidate printers is selected based on a pre-defined fixed priority preference.

This application cross-references and incorporates by reference in its entirety commonly owned U.S. patent application Ser. No. 11/395,520, filed on Mar. 31, 2006, entitled “Print Job Analyzing Method And Apparatus”, and U.S. patent application Ser. No. 12/028,971, filed on Feb. 11, 2008, entitled “Print Job Assignment Method Allowing User-Prioritization”.

### BACKGROUND OF THE INVENTION

1. Field of the Invention

This invention relates to print job processing method and apparatus, and more particularly, to print job processing method and apparatus for a print shop employing multiple printers.

2. Description of Related Art

In an environment that processes a large number of print jobs with multiple printers, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Typically, each printing job specifies a source file that electrically contains a document to be printed, the size, color and the type of the paper on which the document should be printed, the printing resolution, duplex or single-side printing, and certain finishing conditions, such as book, staple, collate printing, etc., depending on a print job requester's needs. In order to process a large volume of print jobs that each differ in terms of these job parameters, a print shop utilizes multiple commercial grade printers. Typically, one or more black & white (B&W) printers are in operation to process B&W printing. Color printers are also installed to handle color printing. Each of these printers, however, has limitations on available printer settings, such as the paper size, the paper type, resolution settings, etc. When a large volume of printing jobs is to be handled with multiple B&W and color printers, it is a daunting task to assign each printing job to an appropriate printer.

### SUMMARY

Accordingly, the present invention is directed to a print job processing method and apparatus that substantially obviates one or more of the problems due to limitations and disadvantages of the related art.

An object of the present invention is to provide an improved print job processing method and apparatus.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for processing a print job implemented in a print job management apparatus for managing a plurality of printing devices, where the method includes: (a) receiving a print job, the print job specifying job ticket parameters representing printing requirements; (b) for each of the plurality of printing devices, determining whether the printing device satisfies all printing requirements of the print job; (c) from all printing devices that are determined to satisfy all printing requirements of the print job, selecting a printing device based on evaluation of one or more real-time conditions of the printing devices; and (d) submitting the print job to the selected printing device for printing. The real-time conditions include one or more of a wait time, a device status, a periodic maintenance count, and an operation history.

In another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a print management system having multiple printers and a print job management server in which embodiments of the present invention can be implemented.

FIG. 2 illustrates a process of setting an operation mode of a print job management process according to an embodiment of the present invention.

FIG. 3 illustrates a print job management process according to an embodiment of the present invention which automatically assigns print jobs to printing devices.

### DETAILED DESCRIPTION OF PREFERRED EMBODIMENTS

Embodiments of the present invention provide a method for automatically assigning print jobs to printers in a print shop environment. An algorithm is used to examine the print job requirements and the capabilities of the printers, and to determine how to assigned the print job to printers. Using this method, a large number of print jobs can be speedily and efficiently processed.

FIG. 1 illustrates an example of a print shop having multiple printers, where embodiments of the present invention may be implemented. In the print shop system, client computers 1 and 2 are connected to a server 4 via a local area network (LAN). Scanner 3 is also connected to server 4 via the LAN. In this example, B&W printers 5, 6, and 7 and color printers 8 and 9 are connected to the server through the LAN. In this example, printers 5-9 are commercial standard high-end printers that can handle high speed, high quality printing. Each of the printers 5-9 has multiple paper trays to store paper of various sizes, color, and types. Further, some of the printers 5-9 are equipped with a sophisticated output sorting mechanism with multiple output trays to perform collate printing or other print finishing functions. Each printer has one or more display monitors to display the status of the printing and various warning and instruction messages to a user. Each printer is equipped with its own central processing unit (CPU) and appropriate hardware/software to control its own printing operations, and communicates with server 4 via a LAN. Some of these printers may also be multifunction printers that can perform copying and scanning of documents. Appropriate server software is installed in server 4 to perform various standard network administrative functions.

According to embodiments of the present invention, in addition to the server administrative software, print job management software is installed on server 4 for managing a large number of print jobs that come into the print shop. The print job management software may be stored in either of a read only memory (ROM) or a hard disk drive (HDD), which can be accessed by the CPU of the server 4. Once a print shop operator calls the print job management software, server 4 reads out the print job management software from the ROM or HDD to a random access memory (RAM) of the server to carry out various functions of the software, including management of print jobs. The print job management software preferably is designed to run on Windows OS, Macintosh OS, or Unix X Windows or other computer operating systems implementing a GUI (graphic user interface), such as a touchscreen and/or a mouse and a keyboard, coupled with a display monitor. Server 4 (or any suitable data processing apparatus) running print job management software of embodiments of the present invention is hereinafter referred to as “print job management server.” In this application, the terms “print job management server” and “print job management apparatus” broadly refer to any data processing apparatus that can implement various features of embodiments of the present invention described below with appropriate hardware/software.

While FIG. 1 shows a print shop environment, the invention is not limited to any physical setting of a shop or network, and can be applied to a print shop system having a distributed setting where printers at different locations are connected to a server. In particular, it should be apparent that one or more of the components of the print shop system can communicate with the rest of the system via virtual private network (VPN) or similar means through the Internet. Moreover, in FIG. 1, although the server 4 functions as the print job management server as well as the network server, a separate stand-alone computer may be provided to run the print job management software. In the alternative, when properly configured, one of the client computers 1 and 2 or the computers attached to one of the printers 5-9 (if such a printer exists among them) may be used to assume the role of the print job management server. Further, a print management system of the present invention can be implemented in a proprietary hardware system that is specifically designed to perform the above-described various functionalities of the print management system.

A print job is a print request specifying various desired options or requirements together with one or more documents to be printed. For example, a customer may bring a floppy diskette containing a file in the PDF format for printing with a particular finishing option. The print shop operator asks the customer what kind of print jobs is desired to figure out print job parameters. Alternatively, the customer may be asked to fill out a questionnaire sheet to describe what print options he/she desires. For example, the customer may desire that the document be printed on 24 lb 25% cotton letter size paper in full color in the double-sided printing mode in the amount of 100 copies. The print shop operator then records these job parameter values along with customer information as a file and stores the file and the source PDF file onto the hard disk drive or other secured storage device so that the print job parameters are associated with the file.

Print jobs also may be generated by a customer's requests to copy a document. When a customer brings a document for copying, the shop operator scans the document using scanner 3 (which may be a color and/or B&W scanner) and converts the document into a digital file and thereafter creates a data file associated with the scanned source document in a manner similar to above.

Theses data files representing print jobs and associated files are forwarded to server 4. This way, numerous print jobs are generated and collected by server 4 on which print job management software is running. The print job management server 4 running print job management software receives the print job files, analyzes and processes the print jobs, and submits them to a printing device for printing and (if required) finishing.

The printing devices to which the server 4 assigns print jobs include printers and clusters. A printer is an actual physical printer (which may include finishing functions such as stapling) that is connected to the server 4. A cluster is a software-defined virtual printing device designed to perform a certain class of print jobs more efficiently and accurately. It is a combination of two or more printers with specified rules or algorithm. When a print job is assigned to a cluster, the print job is split into two or more jobs by a preset or user-defined rule or algorithm, and the divided jobs are processed by the respective printers and/or finishing devices designated by the cluster. The printers within a cluster may also include online finishing devices, i.e., finishing device (sorters, staplers, etc.) that are mechanically and electrically associated with a printer.

Print jobs are organized by using database entries, called “job tickets.” A job ticket specifies values of various print job parameters, and associates itself to the source file(s). In one particular example, a job ticket may include a job ticket number, ticket name as well as the values of the following groups of various other job parameters: job information settings, basic settings (number of copies, orientation of paper, collate, offset printing, original paper size, output paper size, paper type, paper source, etc.), layout settings, cover sheet, finishing settings, inter-sheet settings, tab-paper settings, image quality settings, and customer information.

Based on instructions and information received from a customer, a print shop operator may manually enter the values of these job parameters using a job ticket editor, which is a graphic user interface (GUI). In addition, the server 4 may be configured to access and analyze the source file to determine the values of some of the job parameter directly from the source file. Then the server enters these values in the corresponding job parameter entries in the corresponding job ticket without requiring a user to manually enter them. This will help eliminate clerical errors and further facilitate the operation of the print shop.

Each day, a print shop receives a large number of new print jobs specifying a variety of printing requirements. As arrived, these print jobs are not organized, yet they must be processed promptly and accurately. The print job management server analyzes incoming print jobs and automatically assigns them to the appropriate printing device for printing. As a first step, the print job management server uses a multiple-step process and applies multiple criteria to determine which printing devices satisfy all printing requirements of the print job. Any suitable method may be user to carry out this first step. For example, one such method is described in commonly owned U.S. patent application Ser. No. 12/028,971. After this process, a number of printing devices may be discovered as candidate printing devices, each of which will be able to satisfy all printing requirements of the print job.

Various methods may be employed for selecting, from the multiple candidate printing devices, one printing device to assign the print job to. In a first exemplary method, the server selects a device based on a pre-defined printer priority preference. The printer priority preference is a priority list previously created by an operator manually, based on considerations such as cost of operation of each device. It specifies an order in which printing devices are to be selected by the server if multiple printers can handle the print job. In a second exemplary method, an operator can choose to execute the print job assignment process in one of two alternative modes: a printer priority preference mode (a candidate device is selected based on the predefined printer priority preference) and a minimum wait time mode (a candidate device is selected based on which candidate device has the lowest wait time). These methods were described in the above mentioned commonly owned U.S. patent application.

Embodiments of the present invention provide improved methods for automatically selecting, from all candidate printing devices which will be able to satisfy all printing requirements of the print job, one printing device to assign the print job to. According to embodiments of the present invention, the print job management server selects one of the candidate printing devices based on one or more real-time conditions of the printing devices. The real-time conditions that may be considered by the server include:

Shortest Wait Time: The candidate printing device with the shortest wait time will be selected for assigning the print job to. The wait time of a printing device can be obtained by examining the “time remaining” count of the device.

Device Status: The candidate printing device with a status value most conducive to processing a job will be selected. The status of a printing device may be, for example, Idle/Ready, Warning, Error, etc. A device with an Idle/Ready status will be selected over a device with a Warning status; a device with a Warning status will be selected over a device with an Error status.

Lowest PM Count: The candidate printing device with the lowest PM Count value will be selected. The PM (periodic maintenance) count is a number that indicates the number of pages that has been printed by a printer during the current maintenance period. Each printer is scheduled to print a certain number of pages before the next periodic maintenance is conducted.

Operation History: If certain finishing operations (e.g., staple, punch, fold, etc.) are required by the print job, the usage histories of corresponding finishing units of the candidate printing devices are evaluated. The candidate printing device that has the least number of use occurrences will be selected. For example, if staple is required for the print job, then the printing device that has, over the course of its life, inserted the lowest number of staples will be selected. If multiple finishing units are required by the print job, the histories of the all such units are considered before selecting a printing device.

All of the above real-time conditions are evaluated based on the actual conditions of the printing devices obtained in real time by the server.

The real-time conditions to be considered by the print job management server and the order in which they are considered are specified by an operator prior to assigning print jobs, and stored on the server. A GUI may be provided to specify these conditions and their order. For example, the operator may specify that the operation history, lowest PM count, device status, and shortest wait time be considered in that order. In such an example, the server will first determine which one or ones of the candidate printing devices have the least number of use occurrences of the relevant finishing devices. If two or more devices have equal operation histories, the server will determine which one or ones have the lowest PM count, etc.

In an alternative method of selecting one of the candidate printing devices for the job assignment, the operator can set an operation mode to either a printer priority preference mode or a real-time processing mode. In the printer priority preference mode, a printing device is selected from the multiple candidate devices based on a printer priority preference, which is a priority list of printing devices previously created by an operator and stored on the server. In the real-time processing mode, a printing device is selected from the multiple candidate devices based on evaluation of real-time conditions as described above.

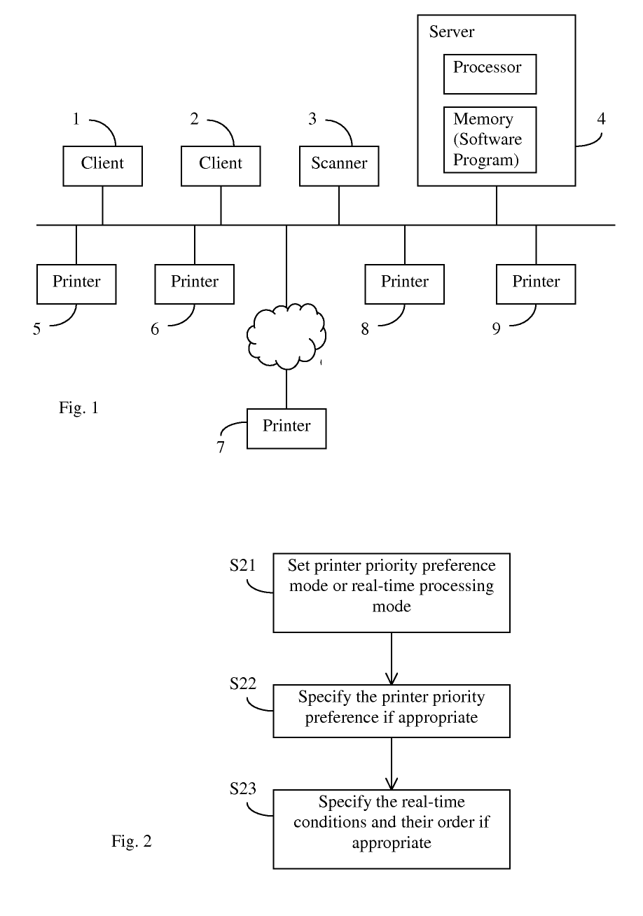

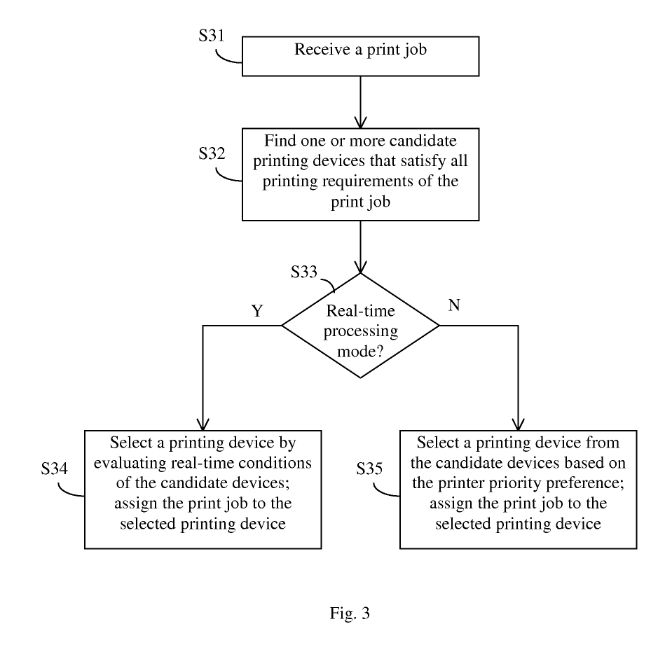

The flow of a print job assignment process according to an embodiment of the present invention is illustrated in FIGS. 2 and 3. First, the operator sets the operation mode to either the printer priority preference mode or the real-time processing mode (step S21). If the printer priority preference mode is set, the operator must make sure that a printer priority preference is previously created or he must create it (step S22). If the real-time processing mode is set, the operator must make sure that one or more real-time conditions and their order (if applicable) are previously specified or he must specify them (step S22). Steps S21 to S23 are performed prior to making a print job assignment. These steps may be repeated to change the operating mode, to change the printer priority preference, or to change the real-time conditions.

When the print job management server receives a print job (step S31), the server analyzes the print job requirements and matches them to the capabilities of each printing devices to find one or more candidate printing devices that satisfy all printing requirements of the print job (step S32). This step may include multiple sub-steps and the server may apply multiple criteria to find the candidate printing devices. The server then determines whether the operation mode is the real-time processing mode (step S33). If it is (“Y” in step S33), the server evaluates real-time conditions of the candidate printing devices to select a printing device in a manner described earlier, and assigns the print job to the selected printing device (step S34). If the operating mode is not the real-time processing mode (“N” in step S33), i.e., it is the printer priority preference mode, the server selects a printing device from the candidate devices based on the printer priority preference, and assigns the print job to the selected printing device (step S35).

Using this print job assignment process, the print job management server automatically selects one of the candidate printing devices in a flexible manner. It allows for consideration of real-time conditions to avoid undesirable results such as print jobs being stalled due to problems with printing devices. It allows for two operation modes, which increases flexibility.

It will be apparent to those skilled in the art that various modification and variations can be made in the print job assignment method and apparatus of the present invention without departing from the spirit or scope of the invention. Thus, it is intended that the present invention cover modifications and variations that come within the scope of the appended claims and their equivalents.

What is claimed is:

1. A method for processing a print job implemented in a print job management apparatus for managing a plurality of printing devices, the method comprising:
(a) receiving a print job, the print job specifying job ticket parameters representing printing requirements;
(b) for each of the plurality of printing devices, determining whether the printing device satisfies all printing requirements of the print job;
(c) from all printing devices that are determined to satisfy all printing requirements of the print job, selecting a printing device based on evaluation of one or more real-time conditions of the printing devices; and
(d) submitting the print job to the selected printing device for printing.

2. The method of claim 1, wherein the real-time conditions of the printing devices include one or more of a wait time, a device status, a periodic maintenance count, and an operation history.

3. The method of claim 1, wherein in step (c) the real-time conditions are evaluated in a pre-defined order.

4. The method of claim 1, further comprising:
(e) determining an operation mode; and
(f) if the operation mode is a first mode, selecting, from all printing devices that are determined in step (b) to satisfy all printing requirements of the print job, a printing device based on a pre-defined priority preference,
wherein step (c) is performed if the operation mode is a second mode.

5. A computer program product comprising a computer usable medium having a computer readable code embodied therein for controlling a data processing apparatus for managing a plurality of printing devices, the computer readable program code being configured to cause the data processing apparatus to execute a process for processing a print job, the process comprising:
(a) receiving a print job, the print job specifying job ticket parameters representing printing requirements;
(b) for each of the plurality of printing devices, determining whether the printing device satisfies all printing requirements of the print job;
(c) from all printing devices that are determined to satisfy all printing requirements of the print job, selecting a printing device based on evaluation of one or more real-time conditions of the printing devices; and
(d) submitting the print job to the selected printing device for printing.

6. The computer program product of claim 5, wherein the real-time conditions of the printing devices include one or more of a wait time, a device status, a periodic maintenance count, and an operation history.

7. The computer program product of claim 5, wherein in step (c) the real-time conditions are evaluated in a pre-defined order.

8. The computer program product of claim 5, wherein the process further comprises:
(e) determining an operation mode; and
(f) if the operation mode is a first mode, selecting, from all printing devices that are determined in step (b) to satisfy all printing requirements of the print job, a printing device based on a pre-defined priority preference,
wherein step (c) is performed if the operation mode is a second mode.
